(19) United States
(12) Patent Application Publication
(10) Pub. No.: US 2026/0371328 A1
(43) Pub. Date: Nov. 19, 2026

(54) SIGNAL TRANSCEIVING METHOD AND APPARATUS AND COMMUNICATION SYSTEM

(71) Applicant: 1FINITY Inc., Kawasaki-shi (JP)

(72) Inventors: Qinyan JIANG, Beijing (CN); Lei ZHANG, Beijing (CN); Xin WANG, Beijing (CN)

(73) Assignee: 1FINITY Inc., Kawasaki-shi (JP)

(21) Appl. No.: 19/751,348

(22) Filed: Jul. 23, 2026

Related U.S. Application Data
(63) Continuation of application No. PCT/CN2024/076832, filed on Feb. 7, 2024.

(51) Int. Cl. H04W 72/0453

(52) U.S. Cl. CPC H04W 72/0453

(57) ABSTRACT

A signal transceiving apparatus, applicable to a terminal equipment, includes: a receiver configured to receive first indication information for indicating a first time domain resource; wherein in the first time domain resource, only a first frequency domain resource is used for transmitting an uplink signal, and/or only a second frequency domain resource is used for receiving a downlink signal; and wherein the first indication information indicates a starting slot and an ending slot of the first time domain resource in a period, a starting symbol of the first time domain resource in the starting slot, and an ending symbol of the first time domain resource in the ending slot.

### CROSS-REFERENCE TO RELATED APPLICATION

This application is a continuation application under 35 U.S.C. 111(a) of International Patent PCT/CN2024/076832 filed on Feb. 7, 2024, and designated the U.S., the entire contents of which are incorporated herein by reference.

### TECHNICAL FIELD

This disclosure relates to the field of communication technologies.

### BACKGROUND

In legacy time division duplexing (TDD), time domain resources are divided into downlink and uplink. At the same time point, only downlink transmission or uplink transmission can be performed. Therefore, allocating limited or fewer uplink time periods will result in reduced coverage and capacity, as well as increased latency. To address this issue, a method may be proposed to enable a network device to support simultaneous existence/occurrence/performing of both downlink and uplink, that is, supporting the network device to transmit and receive signals simultaneously.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

As an SI (study item) of Rel-18, application scenarios, simulation methods and potential standardization impacts of sub-band non-overlapping full duplex (SBFD) have been preliminarily studied in Rel-18. In the upcoming Rel-19, SBFD will be officially standardized as a work item (WI). For SBFD, a network device may operate in a full duplex mode (simultaneous reception and transmission). As a result, the capacity and coverage of uplink transmission may be improved, and latency of uplink transmission may be reduced. However, there is currently no method for how to indicate time domain resources supporting SBFD.

In order to solve at least one of the above problems, embodiments of this disclosure provide a signal transceiving method and apparatus and a communication system.

According to one aspect of the embodiments of this disclosure, there is provided a signal transceiving apparatus, applicable to a terminal equipment, including:
a receiver configured to receive first indication information and/or second indication information for indicating a first time domain resource and/or a second time domain resource;
wherein in the first time domain resource, only a first frequency domain resource is used for transmitting an uplink signal, or only a second frequency domain resource is used for receiving a downlink signal.

According to another aspect of the embodiments of this disclosure, there is provided a signal transceiving apparatus, applicable to a network device, including:
a transmitter configured to transmit first indication information and/or second indication information for indicating a first time domain resource and/or a second time domain resource;
wherein in the first time domain resource, only a first frequency domain resource is used for receiving an uplink signal, or only a second frequency domain resource is used for transmitting a downlink signal.

According to a further aspect of the embodiments of this disclosure, there is provided a communication system, including a terminal equipment and/or a network device,
the terminal equipment including the apparatus as described in the one aspect,
and the network device including the apparatus as described in the other aspect.

An advantage of the embodiments of this disclosure exists in that the network device is supported in performing SBFD operations, and resource allocation flexibility and resource utilization may be improved.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiments of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of the embodiments of this disclosure;

FIG. 2 is a schematic diagram of a signal transceiving method of the embodiments of this disclosure;

FIG. 3 is a schematic diagram of a signal transceiving apparatus of the embodiments of this disclosure;

FIG. 4 is a schematic diagram of a signal transceiving method of the embodiments of this disclosure;

FIG. 5 is a schematic diagram of a signal transceiving apparatus of the embodiments of this disclosure;

FIG. 6 is a schematic diagram of a network device of the embodiments of this disclosure;

FIG. 7 is a schematic diagram of a terminal equipment of the embodiments of this disclosure; and

FIGS. 8A-10C are schematic diagrams of a first time domain resource and/or a second time domain resource of the embodiments of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any level, which may, for example, include but not limited to the following communication protocols: 1G (generation), 2G, 2.5G, 2.75G, 3G, 4G, 4.5G, 5G, New Radio (NR), and 6G etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network services via a network device, which may also be referred to as “a terminal equipment (TE)”. The terminal equipment may be fixed or mobile, and may also be referred to as a mobile station (MS), a terminal, a subscriber station (SS), an access terminal (AT), or a mobile terminal (MT), etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. In this text, “a device” may refer to a network device, and may also refer to a terminal equipment.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, uplink signals may include uplink data signals and/or uplink control signals and/or PRACHs and/or SRSs, etc., and may also be referred to as uplink transmissions (UL transmissions) or uplink information or uplink channels. Transmitting/receiving uplink transmission on an uplink resource may be understood as transmitting/receiving the uplink transmission by using the uplink resource. Downlink signals may include downlink data signals and/or downlink control signals and/or synchronization signals (SSs, such as PSSs/SSSs) and/or broadcast channels (PBCHs) and/or SSBs (SS/PBCH blocks, including PSSs, SSSs, PBCHs and their DMRSs) and/or CSI-RSs, etc., and may also be referred to as downlink transmissions (DL transmissions) or downlink information or downlink channels. Transmitting/receiving downlink transmissions on downlink resources may be understood as transmitting/receiving the downlink transmissions by using the downlink resources.

In the embodiments of this disclosure, higher layer signaling may be, for example, radio resource control (RRC) signaling; for example, it is referred to an RRC message, which includes broadcast/common RRC message/signaling (for example, a MIB, system information), and a dedicated RRC message; or, it is referred to an as an RRC information element (RRC IE), or information fields included in an RRC message or RRC information elements(or information fields included in information fields). Higher layer signaling may also be, for example, media access control (MAC) signaling, or a MAC control element (MAC CE); however, this disclosure is not limited thereto. Names of signaling (such as an RRC message, an information element (IE), an information field, and a higher layer parameter, etc.) used in the embodiments of this disclosure are examples only, and may also be other names, and the embodiments of this disclosure are not limited thereto.

In the embodiments of this disclosure, multiple means at least two, or two or more than two.

In the embodiments of this disclosure, “predefined” means defined in a protocol or determined according to a rule defined in a protocol, without needing additional configuration. Configuration/indication refer(s) to configuring/indicating directly or indirectly by a network device via higher layer signaling and/or physical layer signaling. Configuration/indication may be performed by introducing higher layer parameters into higher layer signaling. The higher layer parameters refer to information fields and/or information elements (IEs)/information elements in the higher layer signaling. The physical layer signaling refers to, for example, control information (DCI) carried by a physical downlink control channel or control information carried by a sequence; however, it is not limited thereto.

For ease of description, following description shall be given by taking that a base station serves as an access network device as an example. In the following description, without causing confusion, “if . . . ”, “in a case where . . . ” and “when . . . ” may be used interchangeably. For resources in the frequency domain, “carrier” and “resource grid” may be interchangeable, and “subcarrier spacing configuration μ” and “subcarrier spacing (SCS) Δf” may be interchangeable. ‘Subcarrier spacing’ and ‘numerology’ may be interchangeable. “Resource block”, “RB” and “PRB”, “physical resource block” and “common resource block (CRB)” may be interchangeable. Configuration/indication/providing/given may be interchangeable. “Index” and “identifier (ID) may be interchangeable.

Scenarios in the embodiments of this disclosure shall be described below by way of examples; however, this disclosure is not limited thereto.

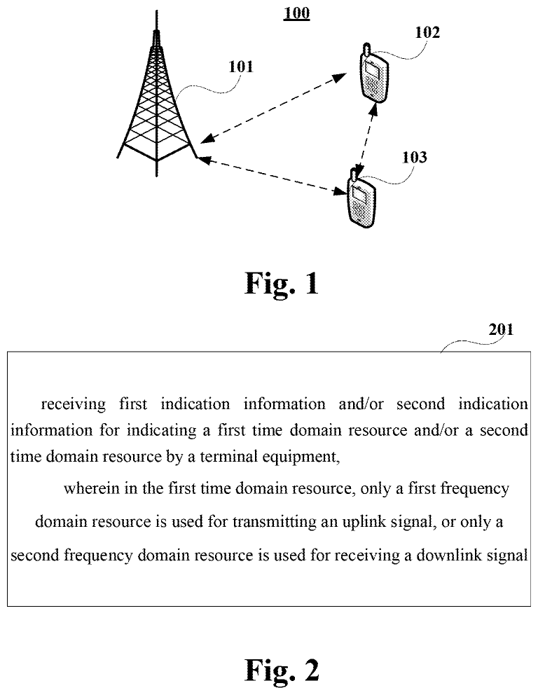

FIG. 1 is a schematic diagram of a communication system of the embodiments of this disclosure, in which a case where terminal equipments and a network device are taken as examples is schematically shown. As shown in FIG. 1, the communication system 100 may include a network device 101 and terminal equipments 102, 103. For the sake of simplicity, an example having only two terminal equipments and one network device is schematically given in FIG. 1; however, the embodiments of this disclosure are not limited thereto.

In the embodiments of this disclosure, existing services or services that may be implemented in the future may be performed between the network device 101 and the terminal equipments 102, 103. For example, such services may include but are not limited to enhanced mobile broadband (eMBB), massive machine type communication (mMTC), and ultra-reliable and low-latency communication (URLLC), etc.

The terminal equipment 102 may transmit data to the network device 101, such as in a granted or grant-free manner. The network device 101 may receive data transmitted by one or more terminal equipments 102 and feed back information to the terminal equipment 102, such as acknowledgement (ACK)/non-acknowledgement (NACK) information. According to the feedback information, the terminal equipment 102 may acknowledge end of a transmission process, or may perform new data transmission, or may perform data retransmission.

The network device 101 may transmit data to the terminal equipment 102 and/or the terminal equipment 103 in a unicast or groupcast or broadcast manner. The terminal equipment 102 may receive data transmitted by one or more network devices (such as dual-connectivity or multi-connectivity) via a downlink or the terminal equipment 103 via a sidelink.

It should be noted that FIG. 1 shows that two terminal equipments 102, 103 are both in coverage of the network device 101. However, this disclosure is not limited thereto, and the two terminal equipments 102, 103 may not be in coverage of the network device 101, or one terminal equipment 102 is in coverage of the network device 101 and the other terminal equipment 103 is out of coverage of the network device 101.

Various implementations of the embodiments of this disclosure shall be described below with reference to the accompanying drawings. These implementations are illustrative only, and are not intended to limit this disclosure.

### Embodiments of a First Aspect

The embodiments of this disclosure provide a signal transceiving method, which shall be describe from a terminal equipment side.

FIG. 2 is a schematic diagram of the signal transceiving method of the embodiments of this disclosure. As shown in FIG. 2, the method includes:

201: a terminal equipment receives first indication information and/or second indication information for indicating a first time domain resource and/or a second time domain resource, wherein in the first time domain resource, only a first frequency domain resource is used for transmitting an uplink signal, or only a second frequency domain resource is used for receiving a downlink signal.

It should be noted that FIG. 2 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

In some embodiments, the first time domain resource is a time domain resource used for (supporting) full-duplex operations (such as SBFD operations), the second time domain resource is a time domain resource not used for (supporting) full-duplex operations (or not used for full-duplex operations, such as non-SBFD), and time locations of the first time domain resource and the second time domain resource are different.

In some embodiments, a first time interval exists between a first time domain resource and a second time domain resource, or, a second time interval exists between transmitting an uplink signal on the first time domain resource and transmitting an uplink signal on the second time domain resource, and/or, a third time interval exists between receiving a downlink signal on the first time domain resource and receiving a downlink signal on the second time domain resource, the first time interval and/or the second time interval being not less than a (minimum) time period used by the terminal equipment to switch a bandwidth and/or a beam and/or transmit power, and the first time interval and/or the third time interval being not less than a (minimum) time period used by the terminal equipment to switch a bandwidth and/or a beam. The minimum time period may be predefined or reported, and the embodiments of this disclosure are not limited thereto.

In some embodiments, the first time interval and/or the second time interval and/or the third time interval is/are predefined and/or reported and/or indicated. For example, the terminal equipment carries information for indicating the above time intervals in capability information transmitted to the network device. The first indication information and/or the second indication information may further indicate the first time interval and/or the second time interval and/or the third time interval, or, the first time interval and/or the second time interval and/or the third time interval may also be indicated by fifth indication information, and the embodiments of this disclosure are not limited thereto.

In some embodiments, the first time domain resource and/or the second time domain resource and/or the time interval include one or more time resource units.

In some embodiments, the time resource unit may include, for example, a symbol and/or a slot and/or a sub-slot and/or a mini-slot and/or a symbol group and/or a slot group and/or a subframe and/or a frame and/or an ms and/or an s, etc.; however, it is not limited thereto. For example, the number of symbols included in a sub-slot or a mini-slot is less than or equal to the number of symbols included in a slot, a symbol group includes one or more (continuous or discontinuous) symbols, and a slot group includes one or more (continuous or discontinuous) slots; however, it is not limited thereto.

In some embodiments, the first time domain resource may also be referred to as an SBFD resource, and the second time domain resource may also be referred to as a non-SBFD resource. The SBFD resource may include, for example, an SBFD time resource unit, such as an SBFD slot and/or symbol, and the non-SBFD resource may include, for example, a non-SBFD time resource unit, such as a non-SBFD slot and/or symbol.

In some embodiments, one slot may include an SBFD symbol and a non-SBFD symbol, or may include only an SBFD symbol, or may include only a non-SBFD symbol.

In some embodiments, the SBFD symbol and/or the interval symbol is/are symbol type(s) parallel to the non-SBFD symbol, or, the SBFD symbol and/or the interval symbol is/are symbol type(s) parallel to a DL symbol and/or a UL symbol and/or a flexible symbol (configured by third indication information and/or fourth indication information, such as tdd-UL-DL-ConfigurationCommon or TDD-UL-DL-ConfigCommon or tdd-UL-DL-ConfigurationDedicated or TDD-UL-DL-ConfigDedicated), wherein the DL symbol, the UL symbol and the flexible symbol belong to the above non-SBFD symbol.

In some embodiments, the terminal equipment may further receive the third indication information and/or the fourth indication information. The third indication information is cell-specific, and the fourth indication information is UE-specific. The third indication information and/or the fourth indication information is/are transmitted via higher layer signaling, or carried by higher layer signaling, or included in higher layer signaling. For example, the third indication information is common TDD uplink downlink configuration information tdd-UL-DL-ConfigurationCommon or TDD-UL-DL-ConfigCommon, and the fourth indication information is dedicated TDD uplink downlink configuration information tdd-UL-DL-ConfigurationDedicated or TDD-UL-DL-ConfigDedicated.

In some embodiments, the third indication information and/or the fourth indication information is/are used to indicate periodic transmission direction of time domain resources, such as indicating that a time unit (such as a slot and/or a symbol) in one period is downlink or uplink.

For example, the third indication information includes at least one of the following information: a subcarrier spacing, pattern 1 or pattern 2. For each pattern, at least one of the following information may be included: a period size (a period of a pattern), the number of downlink slots (the number of consecutive downlink slots from starting locations in the pattern), the number of downlink symbols (the number of consecutive downlink symbols from starting locations in a slot), the number of uplink slots (the number of consecutive uplink slots from ending locations in the pattern), or the number of uplink symbols (the number of consecutive uplink symbols from ending locations in a slot). A slot configuration period P may be provided for pattern 1, and a slot configuration period P2 may be provided for pattern 2.

For example, the fourth indication information includes at least one of the following information: a slot index, or a symbol configuration, the symbol configuration including allDownlink (indicating that symbols in a corresponding slot are all downlink) or allUplink (indicating that symbols in a corresponding slot are all uplink) or explicit (indicating that there are nrofDownlinkSymbols downlink symbols at a starting location and nrofUplinkSymbols uplink symbols at an ending location in a corresponding slot, if nrofDownlinkSymbols is not included, indicating that there is no downlink symbol at the start of the slot, and if nrofUplinkSymbols is not included, indicating that there is no uplink symbol at the end of the slot, and remaining symbols are flexible symbols).

In some embodiments, if one slot and/or a part of symbols in one slot is/are not indicated by the third indication information and/or the fourth indication information as downlink or uplink (including that the third indication information and the fourth indication information are not provided, or that the third indication information and/or the fourth indication information is/are provided but the indication information does not indicate that the slot or the part of symbols is/are downlink or uplink), the symbols and/or the part of symbols in the slot are referred to as, for example, flexible symbols. In other word, the third indication information and/or the fourth indication information indicate(s) that the slot and/or symbols is/are flexible.

In some embodiments, the first indication information and/or the second indication information indicate(s) a time unit belonging to the first time domain resource and/or a time resource unit belonging to the second time domain resource, or, in other words, indicates whether a time resource unit belongs to the first time domain resource or the second time domain resource.

In some embodiments, the first indication information and/or the second indication information is/are carried by higher layer signaling and/or PHY (physical layer) signaling or is/are transmitted via higher layer signaling and/or PHY signaling, or is/are included in higher layer signaling and/or PHY signaling.

In some embodiments, the first indication information is cell-specific (which may also be replaced with common), and the second indication information is UE-specific (which may also be replaced with dedicated), wherein cell-specific refers to that parameter settings are identical for different UEs in a cell (for example, contents broadcast via system information or transmitted via dedicated RRC signaling for different UEs are identical), and UE-specific means that parameter settings may be different for different UEs in a cell (for example, contents transmitted via dedicated RRC signaling for different UEs may be identical or different). For example, if an IE of the first indication information included in the first indication information is included in an IE or message dedicated used for configuring cell-specific parameters, it indicates that the first indication information is cell-specific, and if an IE of the second indication information included in the second indication information is included in an IE or message dedicated used for configuring UE-specific/dedicated parameters, it indicates that the second indication information is UE-specific. However, it is not limited thereto, and in some cases, even if the first indication information is included in a UE-specific/dedicated IE or message, the first indication information may still be cell-specific. For example, the first indication information is included in a system message and/or a common serving cell configuration, and the second indication information is included in a dedicated RRC message and/or a serving cell configuration. In some embodiments, the first indication information and/or the second indication information indicate(s) a time unit belonging to the first time domain resource and/or a time resource unit belonging to the second time domain resource.

In some embodiments, the first time domain resource and/or the second time domain resource is/are periodic, and the first indication information and/or the second indication information indicate(s) a location/locations of the first time domain resource and/or the second time domain resource in one period, or indicate(s) the first time domain resource and/or the second time domain resource in one period.

In some embodiments, the period is predefined or indicated.

In some embodiments, the first indication information and/or the second indication information include(s) information for indicating at least one of the following: a period; an SCS; a location of the first time domain resource in one period; a location of the second time domain resource in one period; or a time interval (the above first time interval and/or the second time interval and/or the third time interval; and information for indicating an associated TDD pattern (such as pattern 1 or pattern 2).

For example, the location of the first time domain resource in one period includes: a first starting slot/first slot offset (in the period), and/or a first starting symbol/first symbol offset (in the period or in the first starting slot), and/or the number of first slots (in the period), and/or the number of first symbols (in the period or in a first ending slot), and/or a first ending symbol/second symbol offset (in the period or in the first ending slot), and/or a first ending slot/second slot offset (in the period).

For example, the location of the second time domain resource in one period includes: a second ending slot/third slot offset (in the period), and/or a second ending symbol (in the period or in the second ending slot), and/or the number of second slots (in the period), and/or the number of second symbols (in the period or in the second ending slot), and/or a second starting slot/fourth slot offset (in the period), and/or a second starting symbol (in the period or in the second starting slot), and/or the number of third slots (in the period), and/or the number of third symbols (in the period or in the second starting slot).

In the above examples, for a second time domain resource located before the first time domain resource, a start of the period is taken as a starting location of the second time domain resource; however, the embodiments of this disclosure are not limited thereto. For example, a starting slot/slot offset and/or a starting symbol/symbol offset (in the starting slot in the period) of the second time domain resource may also be indicated by the first indication information and/or the second indication information, and the embodiments of this disclosure are not limited thereto.

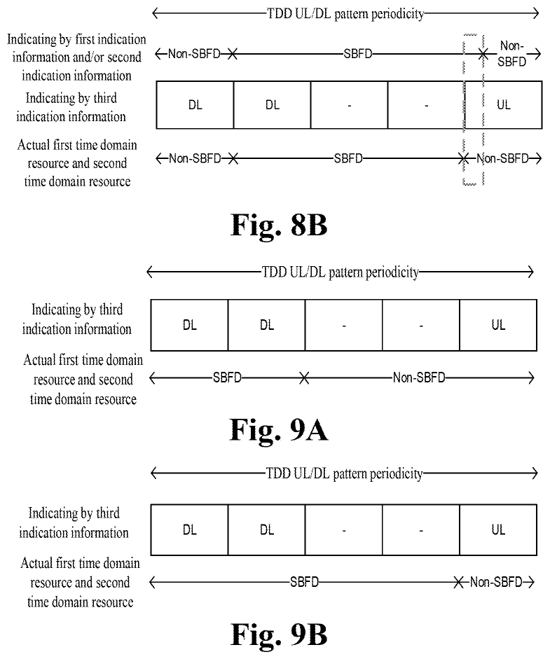

In the above examples, for a second time domain resource located after the second time domain resource, an end of the period is taken as an ending location of the second time domain resource, or, as shown in FIG. 8A, a start of a last uplink slot/symbol in the period is taken as its starting location; however, the embodiments of this disclosure are not limited thereto. For example, its ending slot/slot offset and/or ending symbol/symbol offset (in the ending slot in the period) may also be indicated by the first indication information and/or the second indication information; however, the embodiments of this disclosure are not limited thereto.

In some embodiments, the period may be, for example, a pattern period or a slot configuration period or another indicated period, wherein the pattern period, for example, refers to a period of a corresponding pattern and is indicated by dl-UL-TransmissionPeriod in TDD-UL-DL-Pattern, i.e. a period corresponding to the above P or P2. When only pattern 1 is configured, the slot configuration period is the period of pattern 1. When pattern 1 and pattern 2 are configured, the slot configuration period is a sum period of pattern 1+pattern 2, corresponding to the above period of P+P2.

In some embodiments, first time domain resources are configured respectively for different patterns. For example, when pattern 1 and pattern 2 are configured (that is, the third indication information provides pattern 1 and pattern 2), first time domain resources are respectively configured for pattern 1 and pattern 2, such as configuring the first time domain resources respectively within resources of pattern 1 and within resources of pattern 2.

In some embodiments, the first time domain resource and/or the second time domain resource is/are configured only for pattern 1 or only for pattern 2. For example, when pattern 1 and pattern 2 are configured, the first time domain resource is configured only within the resources of pattern 1, or the first time domain resource is configured only within the resources of pattern, or, only pattern 1 is configured, and the first time domain resource is configured within the resources thereof.

In some embodiments, the first indication information and/or the second indication information directly/explicitly indicate(s) the first time domain resource and/or directly/explicitly indicate(s) the second time domain resource, and/or indirectly/implicitly indicate(s) the first time domain resource or the second time domain resource. For example, the first time domain resource is indicated, and the second time domain resource is indirectly determined according to the first time domain resource, and vice versa. Or, for example, when the second indication information is the fourth indication information, the first time domain resource or the second time domain resource may be indirectly determined according to an uplink or downlink time domain resource indicated by the fourth indication information.

In some embodiments, the second indication information does not indicate the first time domain resource indicated by the first indication information as the second time domain resource (for example, for a time unit indicated by the first indication information as a first time domain resource, the second indication information must indicate the time unit as the first time domain resource), and/or, does not indicate a resource in the second time domain resource indicated by the first indication information that overlaps with a time domain resource not indicated as downlink or uplink by the third indication information as a first time domain resource (or, in other words, does not indicate a resource in the second time domain resource indicated by the first indication information that overlaps with a time domain resource indicated as being flexibly by the third indication information as a first time domain resource; however, it is not limited thereto.

In some embodiments, the third indication information and/or the fourth indication information is/are further used to indicate the first time domain resource and/or the second time domain resource. For example, the first indication information may be included in the third indication information, such as in a TDD-UL-DL-ConfigCommon IE or a TDD-UL-DL-Pattern IE. For example, when it is included in the TDD-UL-DL-Pattern IE, it is optionally present or conditionally optionally present. If it is absent, a corresponding pattern does not include the first time domain resource. The being conditionally optionally present includes, for example, for pattern 1, being optionally present; otherwise, being absent. Or, the first indication information is the third indication information. For example, the second indication information may be included in the fourth indication information, or, the second indication information is the fourth indication information.

In some embodiments, a time domain resource indicated as downlink by the third indication information and indicated as uplink by the fourth indication information belongs to the first time domain resource, and/or a time domain resource that is not indicated as downlink or uplink by the third indication information (a time domain resource indicated as being flexible by the third indication information) and is indicated as uplink by the fourth indication information belongs to the second time domain resource.

In some embodiments, the first indication information and/or the second indication information indicate(s) that symbols in one period are SBFD symbols or DL symbols or UL symbols or flexible symbols or interval symbols respectively, or are SBFD symbols or non-SBFD symbols or interval symbols respectively.

In some embodiments, the first indication information and/or the second indication information indicate(s) types of symbols in one period at a granularity of slot and/or symbol. For example, indicating at a granularity of slot means that a type is indicated for a slot, hence, types of symbols in the slot are identical, and indicating at a granularity of symbol means that types are respectively indicated for different symbols in a slot, hence, types of different symbols in the slot may be identical or different.

In some embodiments, when the first indication information and/or the second indication information is/are provided, the terminal equipment ignores the third indication information and/or the fourth indication information, such as TDD-UL-DL-ConfigCommon or tdd-UL-DL-ConfigurationDedicated or TDD-UL-DL-ConfigDedicated.

How to determine the first time domain resource and the second time domain resource shall be described below.

In some embodiments, the first time domain resource and/or the second time domain resource may be determined according to the first indication information and/or the second indication information and/or the third indication information and/or the fourth indication information. The determined first time domain resource and/or second time domain resource is/are also referred to as an actual first time domain resource and/or an actual second time domain resource.

In some embodiments, the first time domain resource does not overlap with a time domain resource indicated as uplink by the third indication information and/or the fourth indication information, that is, the first time domain resource overlaps only with a time domain resource indicated as downlink by the third indication information and/or the fourth indication information and/or a time domain resource not indicated as downlink or uplink by the third indication information and/or the fourth indication information (such as being referred to as a flexible time domain resource).

In this embodiment, the first time domain resource indicated by the first indication information and/or the second indication information does not overlap with a time domain resource indicated as uplink by the third indication information and/or the fourth indication information, or, the first indication information and/or the second indication information do/does not indicate a time domain resource indicated as uplink by the third indication information and/or the fourth indication information as a first time domain resource, or, the first indication information and/or the second indication information do/does not indicate a first time domain resource from time domain resources indicated as uplink by the third indication information and/or the fourth indication information, or, (determine(s) that) a resource in the first time domain resource indicated by the first indication information and/or the second indication information that overlaps with a time domain resource indicated as uplink by the third indication information and/or the fourth indication information does not belong to the (actual) first time domain resource (in this case, the third indication information and/or the fourth indication information may also be regarded as being used to indicate the first time domain resource and/or the second time domain resource). Or, the terminal equipment does not expect the first time domain resource (indicated by the first indication information and/or the second indication information) overlaps with a time domain resource indicated as uplink by the third indication information and/or the fourth indication information. Or, the terminal equipment does not expect that the third indication information and/or the fourth indication information indicate(s) the first time domain resource (indicated by the first indication information and/or the second indication information) as uplink. Or, (it is determined that) a resource in the first time domain resource indicated by the first indication information and/or the second indication information that overlaps with a time domain resource indicated as uplink by the third indication information and/or the fourth indication information belongs to the (actual) second time domain resource (or, in other words, the third indication information and/or the fourth indication information can change the first time domain resource indicated by the first indication information and/or the second indication information into the second time domain resource.

As shown in FIG. 8A, the first time domain resource indicated by the first indication information and/or the second indication information does not overlap with the time domain resource indicated as uplink by the third indication information. As shown in FIG. 8B, if the first time domain resource indicated by the first indication information and/or the second indication information overlaps with a time domain resource indicated as uplink by the third indication information, the overlapping resources belong to the actual second time domain resource and do not belong to the actual first time domain resource.

In some embodiments, when the first indication information and/or the second indication information is/are not provided, the first time domain resource and/or the second time domain resource is/are predefined. The predefined first time domain resource includes all or a part of time domain resources indicated as downlink by the third indication information and/or the fourth indication information and/or all or a part of time domain resources not indicated as downlink or uplink by the third indication information and/or the fourth indication information, and the other time domain resources are predefined second time domain resources.

In some embodiments, the predefined (actual) first time domain resource is a time domain resource indicated as downlink by the third indication information and/or the fourth indication information, or is a time domain resource indicated as downlink and being flexible by the third indication information and/or the fourth indication information. The predefined (actual) second time domain resource is a time domain resource indicated as uplink by the third indication information and/or the fourth indication information. As shown in FIG. 9A, the predefined (actual) first time domain resource is a time domain resource indicated as downlink by the third indication information. As shown in FIG. 9B, the predefined (actual) first time domain resource is a time domain resource indicated as downlink and being flexible by the third indication information.

In some embodiments, one slot may include a first time domain resource (SBFD symbol) and a second time domain resource (non-SBFD symbol), or may include only a first time domain resource (SBFD symbol), or may include only a non-SBFD symbol.

In some embodiments, at least one of the first time domain resource (SBFD slot/symbol) and the time interval is explicitly configured, and the second time domain resource (non-SBFD slot/symbol) may be implicitly determined as a time domain resource that is not a first time domain resource and time interval.

In some embodiments, at least one of the second time domain resource (SBFD slot/symbol) and the time interval is explicitly configured, and the first time domain resource (non-SBFD slot/symbol) may be implicitly determined as a time domain resource that is not a second time domain resource and time interval.

In some embodiments, at least one of the second time domain resource (non-SBFD slot/symbol) and the first time domain resource (SBFD slot/symbol) is explicitly configured, and the time interval may be implicitly determined as a time domain resource that is not a second time domain resource and first time domain resource. In some embodiments, the terminal equipment does not expect that the first indication information and/or the second indication information coexist(s) with the fourth indication information (that is, the UE does not expect to be provided with the first indication information and/or the second indication information and the fourth indication information simultaneously). If the UE is provided with the first indication information and/or the second indication information, it cannot be provided with the fourth indication information (or, in other words, the UE does not expect to be provided with the fourth indication information).

In some embodiments, the first indication information and/or the second indication information cannot be combined with the fourth indication information to determine the first time domain resource and/or the second time domain resource. For example, the terminal equipment does not expect that the first indication information and/or the second indication information coexist(s) or is/are provided simultaneously with the fourth indication information. When the UE is provided with the fourth indication information, it determines the first time domain resource and/or the second time domain resource according to the fourth indication information, and when the UE is provided with the first indication information and/or the second indication information, it determines the first time domain resource and/or the second time domain resource according to the first indication information and/or the second indication information.

In some embodiments, the first indication information and/or the second indication information can coexist with the fourth indication information (that is, the UE may be provided with the first indication information and/or the second indication information and the fourth indication information simultaneously). However, how the fourth indication information indicates is restricted, which shall be described below in detail.

In some embodiments, the second time domain resource is indicated by the fourth indication information as downlink, and/or is indicated as uplink, and/or cannot be indicated by the fourth indication information as either uplink or downlink (which is also referred to as being indicated as being flexible F/-).

For example, the second time domain resource indicated as downlink by the third indication information (a time domain resource in the second time domain resource indicated by the first indication information and/or the second indication information that overlaps with a time domain resource indicated as downlink by the third indication information) can be indicated by the fourth indication information as downlink or being flexible, that is, cannot indicate it as uplink.

For example, the second time domain resource indicated as uplink by the third indication information (a time domain resource in the second time domain resource indicated by the first indication information and/or the second indication information that overlaps with a time domain resource indicated as uplink by the third indication information) can be indicated by the fourth indication information as uplink or being flexible, that is, cannot indicate it as downlink.

For example, the second time domain resource indicated as being flexible by the third indication information (a time domain resource in the second time domain resource indicated by the first indication information and/or the second indication information that overlaps with a time domain resource indicated as being flexible by the third indication information) can be indicated by the fourth indication information as uplink or being flexible or downlink.

In some embodiments, the first time domain resource is indicated by the fourth indication information as downlink, and/or is indicated as uplink, and/or cannot be indicated by the fourth indication information as uplink or downlink (which is also referred to as being indicated as being flexible F/-).

For example, the first time domain resource indicated as downlink (DL) by the third indication information (a time domain resource in the first time domain resource indicated by the first indication information and/or the second indication information that overlaps with a time domain resource indicated as downlink by the third indication information, also referred to as a third time domain resource) can be indicated by the fourth indication information as downlink or uplink (UL) or being flexible (F/-).

Example 1-1: the fourth indication information can indicate it as DL, or UL, or F/-.

Example 1-2: the fourth indication information can indicate it as DL or F/-, that is, cannot indicate it as UL.

Example 1-3: the fourth indication information must indicate it as DL, that is, cannot indicate it as UL or F/-.

Example 1-4: the fourth indication information must indicate it as F/-, that is, cannot indicate it as UL or DL.

Example 1-5: the fourth indication information must indicate it as UL, that is, cannot indicate it as F/-or DL.

Example 1-6: the fourth indication information can indicate it as UL or F/-, that is, cannot indicate it as DL.

Example 1-7: the fourth indication information must indicate it as UL or DL, that is, cannot indicate it as F/-.

For example, the first time domain resource indicated as being flexible by the third indication information (a time domain resource in the first time domain resource indicated by the first indication information and/or the second indication information that overlaps with a time domain resource indicated as being flexible by the third indication information, also referred to as a fourth time domain resource) can be indicated by the fourth indication information as uplink or being flexible or downlink.

Example 1-1: the fourth indication information can indicate it as DL, or UL, or F/-.

Example 1-2: the fourth indication information can indicate it as DL or F/-, that is, cannot indicate it as UL.

Example 1-3: the fourth indication information must indicate it as DL, that is, cannot indicate it as UL or F/-.

Example 1-4: the fourth indication information must indicate it as F/-, that is, cannot indicate it as UL or DL.

Example 1-5: the fourth indication information must indicate it as UL, that is, cannot indicate it as F/-or DL.

Example 1-6: the fourth indication information can indicate it as UL or F/-, that is, cannot indicate it as DL.

Example 1-7: the fourth indication information must indicate it as UL or DL, that is, cannot indicate it as F/-.

Following description shall be given with reference to the drawings; however, the embodiments of this disclosure is not limited thereto.

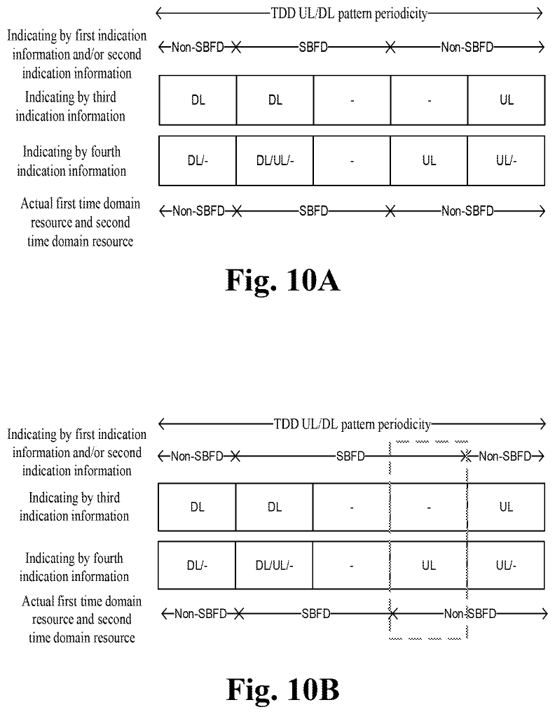

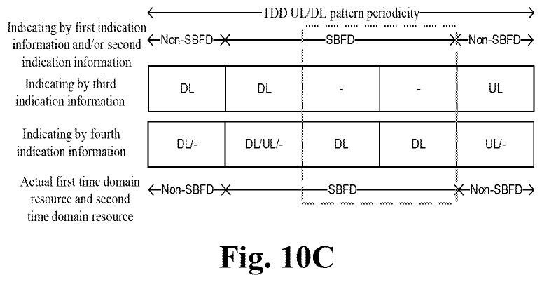

As shown in FIG. 10A, for an indicated second time domain resource, a time domain resource indicated as DL by the third indication information can be indicated as DL or F by the fourth indication information, a time domain resource indicated as UL by the third indication information can be indicated as UL by the fourth indication information, and a time domain resource indicated as F by the third indication information is indicated as UL by the fourth indication information. For an indicated first time domain resource, a time domain resource indicated as DL by the third indication information can be indicated as DL or F or UL by the fourth indication information, and a time domain resource indicated as F by the third indication information (must be) still is indicated as F by the fourth indication information.

As shown in FIG. 10B, a difference from FIG. 10A lies in that for the indicated first time domain resource, a time domain resource indicated as F by the third indication information can be indicated as UL by the fourth indication information, but the time domain resource indicated as UL by the fourth indication information no longer belongs to an actual first time domain resource, and belongs to an actual second time domain resource.

As shown in FIG. 10C, a difference from FIG. 10A lies in that for the first time domain resource, a time domain resource indicated as F by the third indication information must be indicated as DL by the fourth indication information.

A first frequency domain resource and a second frequency domain resource shall be described below.

In some embodiments, the first frequency domain resource includes a frequency domain resource in a (active) UL BWP that overlaps with a first frequency domain resource unit set (for example, the first frequency domain resource unit set includes, but is not limited to, a first sub-band on/in a corresponding DL carrier of a DL BWP corresponding to the UL BWP (for example, the DL BWP corresponding to the active UL BWP is the active DL BWP), or, a frequency domain resource in a (active) UL BWP that belongs to a second frequency domain resource unit set (for example, the second frequency domain resource unit set includes a first sub-band on/in a corresponding UL carrier of the UL BWP), or, a third frequency domain resource unit set (for example, the third frequency domain resource unit set includes a first sub-band on/in the UL BWP); and/or, the second frequency domain resource includes a frequency domain resource in a (active) DL BWP that overlaps with a fourth frequency domain resource unit set (for example, the fourth frequency domain resource unit set includes a second sub-band on a corresponding UL carrier of a UL BWP corresponding to the DL BWP (for example, the UL BWP corresponding to the active DL BWP is the active UL BWP), or, a frequency domain resource in a (active) DL BWP that belongs to a fifth frequency domain resource unit set (for example, the fifth frequency domain resource unit set includes a second sub-band on a corresponding DL carrier of the DL BWP), or, a sixth frequency domain resource unit set in a (active) DL BWP (for example, the sixth frequency domain resource unit set includes a second sub-band on/in the DL BWP). In the following description, a sub-band and a frequency domain resource unit set are interchangeable.

The first sub-band and the second sub-band, for example, are used to support SBFD operation (of the network device). From the perspective of the network device, in a time period, the network device may receive a (uplink) signal on the first sub-band while transmitting a (downlink) signal on the second sub-band. Thus, a possibility of transmitting and receiving signals simultaneously may be achieved (whether to receive and/or transmit is also dependent on other configurations and/or scheduling). From the perspective of the terminal equipment, in this time period, the terminal equipment may transmit a (uplink) signal on the first sub-band or receive a (downlink) signal on the second sub-band (whether to transmit and/or receive is also dependent on other configurations and/or scheduling).

In some embodiments, (configuration of) the first sub-band and/or the second sub-band is/are for a same cell or within a cell, or, in other words, the above SBFD operations are for the same cell or within a cell. From the perspective of the network device, within the same cell, in one time period, the network device may receive a (uplink) signal on the first sub-band while transmitting a (downlink) signal on the second sub-band. From the perspective of the terminal equipment, within the cell, in the time period, the terminal equipment may transmit a (uplink) signal on the first sub-band and receive a (downlink) signal on the second sub-band.

In some embodiments, a third sub-band is, for example, a guard interval between the first sub-band and the second sub-band. The first sub-band and/or the second sub-band and/or the third sub-band may include one or more continuous frequency domain resource units or multiple discontinuous frequency domain resource units, or, the first sub-band and the second sub-band are composed of one or more continuous frequency domain resource units or multiple discontinuous frequency domain resource units. The frequency domain resource unit includes one or more of following: a subcarrier, a subcarrier set/group, an RB, or an RB set/group, etc. The number of subcarriers included in a subcarrier group may or may not be a multiple of the number of subcarriers included in one RB. For example, the number of subcarriers included in the subcarrier group is less than the number of subcarriers included in one RB; however, it is not limited thereto, and an RB group, for example, includes multiple RBs.

For example, the frequency domain resource unit includes one of: a subcarrier, a subcarrier group, an RB, and an RB group, the one is an RB, and the first sub-band includes one or more continuous RBs or multiple discontinuous RBs. For another example, the frequency domain resource unit includes a subcarrier and an RB, and the first sub-band may include an integer number of RBs and an integer number of subcarriers, and the integer number of RBs and the integer number of subcarriers may be continuous or discontinuous.

In some embodiments, the number of frequency domain resource units included in the first sub-band and/or the second sub-band (must be) is a multiple of N1, and/or a common multiple of N2, N3 and N4. For example, N1=2 or 4, N2=2, N3=3, and N4=5, or, it may be other values; however, it is not limited thereto.

In some embodiments, the first sub-band may also be referred to as an uplink sub-band (UL sub-band), or an uplink SBFD sub-band, or an SBFD uplink sub-band, an uplink RB set (i.e. an RB set used for uplink), or an uplink SBFD RB set, or an SBFD uplink RB set; however, the embodiments of this disclosure are not limited thereto.

In some embodiments, the second sub-band may also be referred to as a downlink sub-band (DL sub-band), or a downlink SBFD sub-band, or an SBFD downlink sub-band, or a downlink RB set (an RB set used for downlink), or a downlink SBFD RB set, or an SBFD downlink RB set; however, the embodiments of this disclosure are not limited thereto.

In some embodiments, there is no guard interval or there is a guard band (GB) between the first sub-band (such as a UL sub-band) and the second sub-band (such as a DL sub-band).

In some embodiments, the terminal equipment may further receive first information and/or second information used for indicating/configuring the first frequency domain resource unit set and/or the second frequency domain resource unit set and/or the third frequency domain resource unit set and/or the fourth frequency domain resource unit set and/or the fifth frequency domain resource unit set and/or the sixth frequency domain resource unit set.

In some embodiments, the first information and/or the second information is/are carried by higher layer signaling and/or PHY signaling, or is/are transmitted via higher layer signaling and/or PHY signaling, or is/are included in higher layer signaling and/or PHY signaling. The first information and the second information are carried by identical or different signaling or messages or information elements (IEs). For example, the first information and the second information are respectively included in a system message and a dedicated RRC message. For another example, the first information and the second information are respectively included in different (numbered) system messages. For a further example, the first information and the second information are respectively included in RRC signaling and PHY signaling.

In some embodiments, all or a part of the first information and/or the second information is/are carried by RRC signaling.

In some embodiments, the first information and the second information are included in an RRC message and/or a third configuration, the message including one or more of the following:
a MIB;
a SIB1;
a system information (such as SystemInformation) message;
an RRC setup (such as RRCSetup) message;
an RRC resume (such as RRCResume) message;
an RRC reconfiguration (such as RRCReconfiguration) message,
wherein
the third configuration (such as an RRC IE) includes one or more of the following:
SIB downlink frequency information (such as FrequencyInfoDL-SIB),
a SIB downlink common configuration (such as DownlinkConfigCommonSIB),
SIB uplink frequency information (such as FrequencyInfoUL-SIB),
a SIB uplink common configuration (such as UplinkConfigCommonSIB),
a SIB serving cell common configuration (such as ServingCellConfigCommonSIB),
downlink frequency information (such as FrequencyInfoDL),
downlink common configuration (such as DownlinkConfigCommon),
uplink frequency information (such as FrequencyInfoUL),
an uplink common configuration (such as UplinkConfigCommon),
a serving cell common configuration (such as ServingCellConfigCommon),
a serving cell configuration (such as ServingCellConfig),
a SIBx, or
a field or IE for configuring a BWP.

For example, FrequencyInfoDL-SIB is included in DownlinkConfigCommonSIB, FrequencyInfoUL-SIB may be included in UplinkConfigCommonSIB, DownlinkConfigCommonSIB and UplinkConfigCommonSIB may be included in ServingCellConfigCommonSIB, ServingCellConfigCommonSIB may be included in SIB1. FrequencyInfoDL may be included in DownlinkConfigCommon, FrequencyInfoUL may be included in UplinkConfigCommon, DownlinkConfigCommon and UplinkConfigCommon may be included in ServingCellConfigCommon, ServingCellConfigCommon and ServingCellConfig may be included in the RRC setup (RRCSetup) message and/or the RRC resume (RRCResume) message and/or the RRC reconfiguration (RRCReconfiguration) message; however, it is not limited thereto. an SIBx is a system information block different from an SIB1, for example, x=15 or may be other values, and/or may be dedicated to SBFD operations, and/or may be included in a system information (SystemInformation) message, and/or, only a UE (such as an SBFD-aware UE) satisfying a certain condition (including supporting a specific capability, such as supporting SBFD operations and/or being aware of SBFD operations (of the network device) and/or being able to perform corresponding (optimized/enhanced) signal transmission/reception (for SBFD operations) (when the network device performs SBFD operations) receives the SIBx; however, it is not limited thereto.

In some embodiments, the first information and/or the second information include(s) one or more first configurations.

In some embodiments, the first information and/or the second information is/are, for example, a list of first configurations (including one or more first configurations. The first configuration includes a first information element and/or one or more information fields (for indicating a frequency domain location of the first sub-band).

In some embodiments, the first configuration includes information (or an information field) for indicating one or more of the following: a frequency domain location(s) (a start(s) and/or end(s) and/or center(s) and/or bandwidth(s) of one or a group of first sub-bands; a frequency domain location(s) (a start(s) and/or end(s) and/or center(s) and/or bandwidth(s) of one or a group of second sub-bands; an index/indices; a subcarrier spacing/subcarrier spacings; or a reference point/reference points.

In some embodiments, the first sub-band and/or the second sub-band and/or the third sub-band is/are configured for a cell or a (DL and/or UL) SCS specific carrier or a (DL and/or UL) BWP. For example, the first information and/or the second information configure(s) the first sub-band and/or the second sub-band and/or the third sub-band for a cell or a (DL and/or UL) SCS specific carrier or a (DL and/or UL) BWP. For example, for a cell means that a configured first sub-band and/or second sub-band and/or third sub-band is/are applicable to different SCS specific carriers and/or BWPs of the cell. For a (DL and/or UL) SCS specific carrier means that a configured first sub-band and/or second sub-band and/or third sub-band is/are applicable to a (DL and/or UL) SCS specific carrier with/to which it is associated/corresponds, and thus applicable to a (DL and/or UL) BWP corresponding to the (DL and/or UL) SCS specific carrier. For example, corresponding first sub-bands and/or second sub-bands and/or third sub-bands are respectively configured for different SCSs or different (DL and/or UL) SCS specific carriers in a cell. For a (DL and/or UL) BWP means, for example, that a configured first sub-band and/or second sub-band and/or third sub-band is/are applicable to a (DL and/or UL) BWP with/to which it is associated/corresponds. For example, corresponding first sub-bands and/or second sub-bands and/or third sub-bands are respectively configured for different (DL and/or UL) BWPs in a cell.

In some embodiments, a DL BWP corresponds to or is associated with a DL SCS-specific carrier having the same SCS as the DL BWP and/or a UL SCS specific carrier having the same SCS as a UL BWP associated with the DL BWP. A UL BWP corresponds to or is associated with a UL SCS specific carrier having the same SCS as the UL BWP and/or a DL SCS specific carrier having the same SCS as a DL BWP associated with the UL BWP.

In some embodiments, the first information and/or the second information indicate(s) the first sub-band and/or the second sub-band and/or the third sub-band for a cell, and the UE determines the first sub-band and/or the second sub-band and/or the third sub-band for a (DL and/or UL) SCS specific carrier and/or a (DL and/or UL) BWP according to the indicated first sub-band and/or second sub-band and/or third sub-band.

In some embodiments, the first information and/or the second information indicate(s) the first sub-band and/or the second sub-band and/or the third sub-band for a (DL and/or UL) SCS specific carrier, and the UE determines the first sub-band and/or the second sub-band and/or the third sub-band for a (DL and/or UL) BWP according to the indicated first sub-band and/or second sub-band and/or third sub-band.

In some embodiments, the first information and/or the second information indicate(s) the first sub-band and/or the second sub-band and/or the third sub-band for a DL SCS specific carrier, and the UE determines the first sub-band and/or the second sub-band and/or the third sub-band for a (associated) UL SCS specific carrier and/or a (DL and/or UL) BWP according to the indicated first sub-band and/or second sub-band and/or third sub-band.

In some embodiments, the first information and/or the second information indicate(s) the first sub-band and/or the second sub-band and/or the third sub-band for a UL SCS specific carrier, and the UE determines the first sub-band and/or the second sub-band and/or the third sub-band for a (associated) DL SCS specific carrier and/or a (DL and/or UL) BWP according to the indicated first sub-band and/or second sub-band and/or third sub-band.

In some embodiments, assuming that the first sub-band and/or the second sub-band and/or the third sub-band is/are configured for a DL SCS specific carrier, for a DL BWP, the UE determines an overlapping relationship between frequency domain resources therein and these sub-bands according to the first sub-band and/or the second sub-band and/or the third sub-band of its corresponding DL SCS specific carrier. For a UL BWP, the UE determines an overlapping relationship between frequency domain resources therein and these sub-bands according to the first sub-band and/or the second sub-band and/or the third sub-band of a DL SCS specific carrier corresponding to a DL BWP corresponding to the UL BWP, or, the UE determines an overlapping relationship between frequency domain resources therein and these sub-bands according to the first sub-band and/or the second sub-band and/or the third sub-band of a UL SCS specific carrier corresponding to the UL BWP, wherein the first sub-band and/or the second sub-band and/or the third sub-band of the UL SCS specific carrier is/are determined according to the first sub-band and/or the second sub-band and/or the third sub-band of a DL SCS specific carrier corresponding to a DL BWP to which the UL BWP corresponds. The first information and/or the first indication information may be configured by identical or different information fields/carried by identical or different signaling, and the second information and/or the second indication information may be configured by identical or different information fields/carried by identical or different signaling, which shall not be enumerated herein any further.

How the terminal equipment receives or transmits signals shall be described below. Following first time domain resource and/or second time domain resource may be an indicated first time domain resource and/or second time domain resource or may be an actual first time domain resource and/or second time domain resource, and may be indicated based on a first SCS and/or a first CP, or may be determined according to a second SCS and/or a second CP. The first SCS and the second SCS may be identical or different, and the first CP and/or the second CP may be a normal cyclic prefix(es) (normal CP(s)) and/or an extended cyclic prefix(es) (extended CP(s)), and the embodiments of this disclosure are not limited thereto.

In some embodiments, in the first time domain resource, only the first frequency domain resource is used for transmitting an uplink signal, or only the second frequency domain resource is used for receiving a downlink signal. That is, in the first time domain resource, the terminal equipment transmits an uplink signal only in all or a part of the first frequency domain resource, or receives a downlink signal only in all or a part of the second frequency domain resource. For the first time domain resource, frequency domain resources included in the (active) UL BWP other than the first frequency domain resource are not used for transmitting an uplink signal, and/or frequency domain resources included in the (active) DL BWP other than the second frequency domain resource are not used for receiving a downlink signal.

In some embodiments, in the second time domain resource, the first frequency domain resource and frequency domain resources other than the first frequency domain resource are used for transmitting an uplink signal, and/or a downlink signal is received in the second frequency domain resource and frequency domain resources other than the second frequency domain resource. That is, in the second time domain resource, the terminal equipment may transmit an uplink signal on a frequency domain resource other than the first frequency domain resource and/or receive a downlink signal on a frequency domain resource other than the second frequency domain resource, that is, it may transmit an uplink signal on (all or a part of) the first frequency domain resource and/or frequency domain resources other than the first frequency domain resource, and receive a downlink signal on the second frequency domain resource and/or frequency domain resources other than the second frequency domain resource. For the second time domain resource, the first frequency domain resource and frequency domain resources other than the first frequency domain resource (such as including all frequency domain resources in the UL BWP) included in an (activated) UL BWP are used for transmitting an uplink signal, and/or the second frequency domain resource and frequency domain resources other than the second frequency domain resource (such as including all frequency domain resources in the DL BWP) included in the (active) DL BWP are used for receiving a downlink signal.

The steps or processes related to this disclosure are only described above; however, this disclosure is not limited thereto. The method of the embodiments of this disclosure may also include other steps or processes, and reference may be made to relevant techniques for specific contents of these steps or processes.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, the network device is supported in performing SBFD operations, and resource allocation flexibility and resource utilization may be improved.

### Embodiments of a Second Aspect

The embodiments of this disclosure provide a signal transceiving apparatus. The apparatus may be, for example, a terminal equipment, or one or some components or assemblies configured in the terminal equipment, with contents identical to those in the embodiments of the first aspect being not going to be described herein any further.

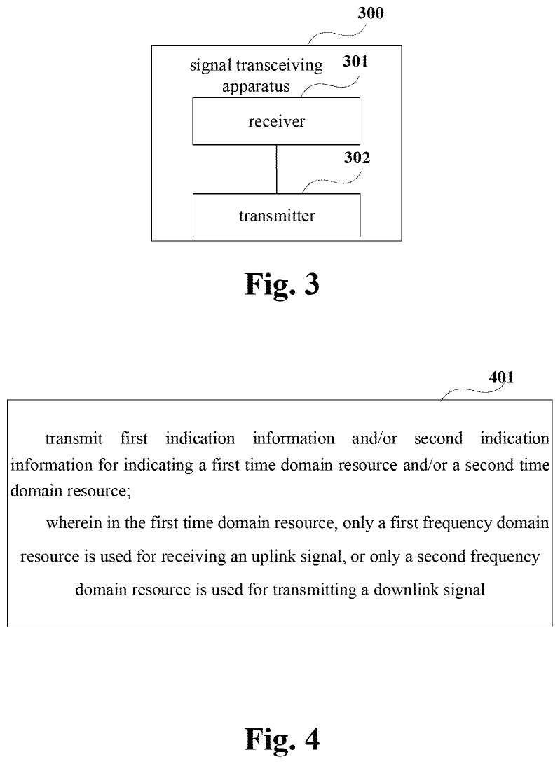

FIG. 3 is a schematic diagram of the signal transceiving apparatus of the embodiments of this disclosure. As a principle of the signal transceiving apparatus is identical to that of the method in the embodiments of the first aspect, reference may be made to the embodiments of the first aspect for implementation of the apparatus, with identical parts being not going to be described herein any further.

As shown in FIG. 3, the signal transceiving apparatus 300 of the embodiments of this disclosure includes:
a receiver 301 configured to receive first indication information and/or second indication information for indicating a first time domain resource and/or a second time domain resource,
wherein in the first time domain resource, only a first frequency domain resource is used for transmitting an uplink signal, or only a second frequency domain resource is used for receiving a downlink signal.

Reference may be made to 201 in the first aspect for implementation of the receiver 301, and repeated parts shall not be described herein any further.

The apparatus may further include a transmitter 302 configured to transmit a signal to a network device, and the receiver 301 may further be configured to receive a signal transmitted by the network device.

Furthermore, for the sake of simplicity, connection relationships between the components or modules or signal profiles thereof are only illustrated in FIG. 3. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Third Aspect

The embodiments of this disclosure provide a signal transceiving method, which shall be describe from a network device side, with contents identical to those in the embodiments of the first aspect being not going to be described herein any further.

FIG. 4 is a schematic diagram of the signal transceiving method of the embodiments of this disclosure. As shown in FIG. 4, the method includes:

401: a network device transmits first indication information and/or second indication information for indicating a first time domain resource and/or a second time domain resource;
wherein in the first time domain resource, only a first frequency domain resource is used for receiving an uplink signal, or only a second frequency domain resource is used for transmitting a downlink signal.

Reference may be made to 201 in the first aspect for implementation of 401, and repeated parts shall not be described herein any further.

In some embodiments, in the first time domain resource, the network device may transmit a downlink signal to a terminal equipment on the first frequency domain resource and receive an uplink signal transmitted by another terminal equipment on a frequency domain resource other than the first frequency domain resource, and/or receive an uplink signal transmitted by a terminal equipment on the second frequency domain resource and transmit a downlink signal to another terminal equipment on a frequency domain resource other than the second frequency domain resource, so that the network device supports simultaneous existence/occurrence/performing of downlink and uplink.

The steps or processes related to this disclosure are only described above; however, this disclosure is not limited thereto. The method of the embodiments of this disclosure may also include other steps or processes, and reference may be made to relevant techniques for specific contents of these steps or processes.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Fourth Aspect

The embodiments of this disclosure provide a signal transceiving apparatus. The apparatus may be, for example, a network device, or one or some components or assemblies configured in the network device, with contents identical to those in the embodiments of the third aspect being not going to be described herein any further.

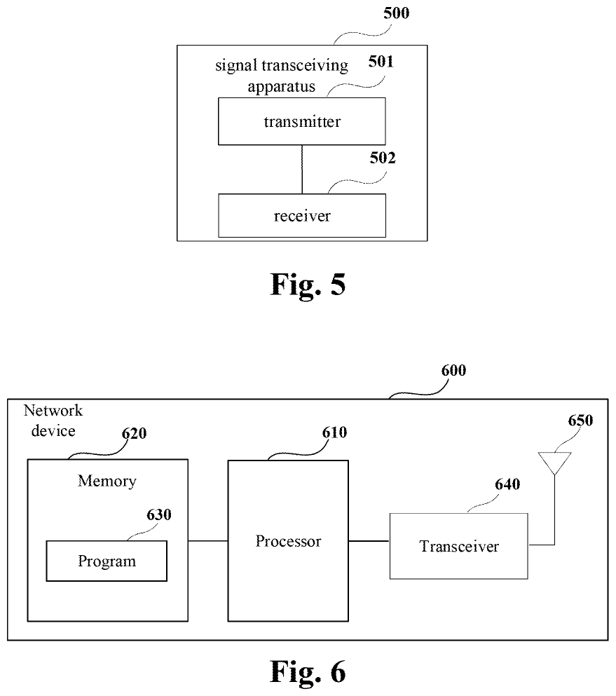

FIG. 5 is a schematic diagram of the signal transceiving apparatus of the embodiments of this disclosure. As a principle of the signal transceiving apparatus is identical to that of the method in the embodiments of the third aspect, reference may be made to the embodiments of the third aspect for implementation of the apparatus, with identical parts being not going to be described herein any further.

As shown in FIG. 5, the signal transceiving apparatus 500 of the embodiments of this disclosure includes:
a transmitter 501 configured to transmit first indication information and/or second indication information for indicating a first time domain resource and/or a second time domain resource;
wherein in the first time domain resource, only a first frequency domain resource is used for receiving an uplink signal, or only a second frequency domain resource is used for transmitting a downlink signal.

The apparatus may further include a receiver 502 configured to receive a signal transmitted by a terminal equipment, and the transmitter may further be configured to transmit a signal to the terminal equipment.

Reference may be made to the embodiments of the first aspect for implementations of the above features, which shall not be described herein any further.

It should be noted that the components or modules related to this disclosure are only described above. However, this disclosure is not limited thereto, and the signal transceiving apparatus 500 of the embodiments of this disclosure may further include other components or modules, and reference may be made to related techniques for particulars of these components or modules.

Furthermore, for the sake of simplicity, connection relationships between the components or modules or signal profiles thereof are only illustrated in FIG. 5. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Fifth Aspect

The embodiments of this disclosure provide a communication system, and reference may be made to FIG. 1, with contents identical to those in the embodiments of the first to the fourth aspects being not going to be described herein any further.

In some embodiment, the communication system 100 may at least include a network device 101 and a terminal equipment 102, the network device 101 including the signal transceiving apparatus 500 as described in the embodiments of the fourth aspect, and the terminal equipment 102 including the signal transceiving apparatus 300 as described in the embodiments of the second aspect, which shall not going to be described herein any further.

The embodiments of this disclosure further provide a network device, which may be, for example, a base station. However, this disclosure is not limited thereto, and it may also be another network device.

FIG. 6 is a schematic diagram of a structure of the network device of the embodiments of this disclosure. As shown in FIG. 6, the network device 600 may include a processor 610 (such as a central processing unit (CPU)) and a memory 620, the memory 620 being coupled to the processor 610. Wherein, the memory 620 may store various data, and furthermore, it may store a program 630 for information processing, and execute the program 630 under control of the processor 610.

For example, the processor 610 may be configured to execute a program to carry out the method described in the embodiments of the third aspect.

Furthermore, as shown in FIG. 6, the network device 600 may include a transceiver 640, and an antenna 650, etc., wherein functions of the above components are similar to those in the related art, and shall not be described herein any further. It should be noted that the network device 600 does not necessarily include all the parts shown in FIG. 6, and furthermore, the network device 600 may include parts not shown in FIG. 6, and the related art may be referred to.

The embodiments of this disclosure further provide a terminal equipment; however, this disclosure is not limited thereto, and it may also be another equipment.

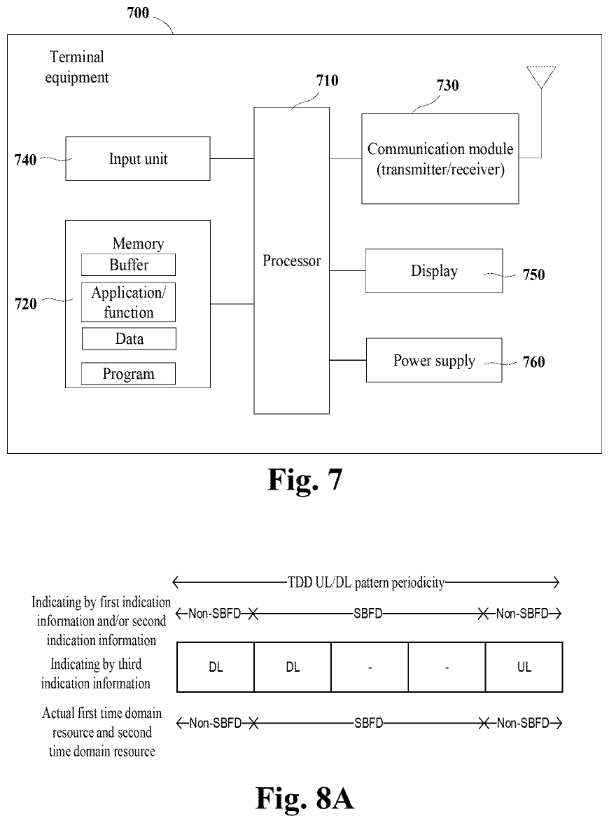

FIG. 7 is a schematic diagram of the terminal equipment of the embodiments of this disclosure. As shown in FIG. 7, the terminal equipment 700 may include a processor 710 and a memory 720, the memory 720 storing data and a program and being coupled to the processor 710. It should be noted that this figure is illustrative only, and other types of structures may also be used, so as to supplement or replace this structure and achieve a telecommunications function or other functions.

For example, the processor 710 may be configured to execute a program to carry out the method described in the embodiments of the first aspect.

As shown in FIG. 7, the terminal equipment 700 may further include a communication module 730, an input unit 740, a display 750, and a power supply 760, wherein functions of the above components are similar to those in the related art, which shall not be described herein any further. It should be noted that the terminal equipment 700 does not necessarily include all the parts shown in FIG. 7, and the above components are not necessary. Furthermore, the terminal equipment 700 may include parts not shown in FIG. 7, and the related art may be referred to.

Embodiments of this disclosure provide a computer program, which, when executed in a signal transceiving apparatus or a network device, will cause a computer to carry out the method as described in the embodiments of the third aspect in the signal transceiving apparatus or the network device.

Embodiments of this disclosure provide a storage medium, including a computer program, which will cause a computer to carry out the method as described in the embodiments of the third aspect in a signal transceiving apparatus or a network device.

Embodiments of this disclosure provide a computer program, which, when executed in a signal transceiving apparatus or a terminal equipment, will cause a computer to carry out the method as described in the embodiments of the first aspect in the signal transceiving apparatus or the terminal equipment.

Embodiments of this disclosure provide a storage medium, including a computer program, which will cause a computer to carry out the method as described in the embodiments of the first aspect in a signal transceiving apparatus or a terminal equipment.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this disclosure. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the spirits and principle of this disclosure, and such variants and modifications fall within the scope of this disclosure.
1. A signal transceiving method, including:
receiving first indication information and/or second indication information for indicating a first time domain resource and/or a second time domain resource by a terminal equipment,
wherein in the first time domain resource, only a first frequency domain resource is used for transmitting an uplink signal, and/or only a second frequency domain resource is used for receiving a downlink signal.
2. The method according to supplement 1, wherein the first time domain resource is an SBFD resource, and the second time domain resource is a non-SBFD resource.
3. The method according to supplement 1, wherein the method further includes:
in the first time domain resource, transmitting an uplink signal only in (all or a part of) the first frequency domain resource, and in the second time domain resource, transmitting an uplink signal in the first frequency domain resource and/or (all or a part of) frequency domain resources other than the first frequency domain resource, by the terminal equipment.
4. The method according to supplement 1, wherein the method further includes:
in the first time domain resource, receiving a downlink signal only in (all or a part of) the second frequency domain resource, and in the second time domain resource, receiving a downlink signal in the second frequency domain resource and/or (all or a part of) frequency domain resources other than the second frequency domain resource, by the terminal equipment.
5. The method according to supplement 1, wherein the method further includes:
determining the first time domain resource and/or the second time domain resource by the terminal equipment according to the first indication information and/or the second indication information and/or third indication information and/or fourth indication information.
6. The method according to supplement 1, wherein the first indication information and/or the second indication information is/are carried by radio resource control (RRC) signaling and/or media access control (MAC) signaling and/or physical layer (PHY) signaling.
7. The method according to supplement 6, wherein the first indication information is included in a system message and/or a common serving cell configuration, and the second indication information is included in a dedicated RRC message and/or a serving cell configuration.
8. A terminal equipment, including a memory and a processor, the memory storing a computer program, and the processor being configured to execute the computer program to carry out the method as described in supplement 1.
9. A computer program product, at least including a computer program, the computer program, when executed by a processor, will cause a terminal equipment to carry out the method as described in supplement 1.
10. A communication system, including the terminal equipment as described in supplement 8.

1. A signal transceiving apparatus, applicable to a terminal equipment, the apparatus comprising:
a receiver configured to receive first indication information for indicating a first time domain resource;
wherein in the first time domain resource, only a first frequency domain resource is used for transmitting an uplink signal, and/or only a second frequency domain resource is used for receiving a downlink signal; and
wherein the first indication information indicates a starting slot and an ending slot of the first time domain resource in a period, a starting symbol of the first time domain resource in the starting slot, and an ending symbol of the first time domain resource in the ending slot.

2. The apparatus according to claim 1, wherein the receiver is further configured to receive second indication information for indicating a second time domain resource.

3. The apparatus according to claim 2, wherein the first time domain resource is an SBFD (sub-band non-overlapping full duplex) resource, and the second time domain resource is a non-SBFD resource.

4. The apparatus according to claim 2, wherein the first indication information and/or the second indication information is/are carried by RRC (radio resource control) signaling, and the first indication information is cell-specific, and the second indication information is UE-specific.

5. The apparatus according to claim 2, wherein the receiver further receives third indication information, the third indication information comprising at least one of the following: an SCS (subcarrier spacing), pattern 1, or pattern 2; and
wherein when only pattern 1 is configured, a configuration period of the first time domain resource is a period (P) to which pattern 1 corresponds, and when pattern 1 and pattern 2 are configured, a configuration period of the first time domain resource is a sum of the period (P) to which pattern 1 corresponds and a period (P2) to which pattern 2 corresponds.

6. The apparatus according to claim 5, wherein when pattern 1 and pattern 2 are configured, the first time domain resource is able to be configured in pattern 1 and/or pattern 2.

7. The apparatus according to claim 6, wherein the third indication information comprises the first indication information, and the first indication information is optional in a TDD (time division duplexing)-UL (uplink)-DL (downlink)-Pattern in the third indication information, wherein the first indication information in the TDD-UL-DL-Pattern is used for configuring the first time domain resource in a corresponding pattern.

8. The apparatus according to claim 7, wherein the first time domain resource determined by the third indication information cannot change to the second time domain resource, and/or, the second time domain resource determined by the third indication information cannot change to the first time domain resource.

9. The apparatus according to claim 5, wherein the first time domain resource does not overlap with a time domain resource indicated as uplink by the third indication information, and/or, a time domain resource indicated as uplink by the third indication information is the second time domain resource.

10. The apparatus according to claim 2, wherein the second time domain resource is a time resource other than the first time domain resource.

11. The apparatus according to claim 1, wherein the first frequency domain resource comprises a frequency domain resource both in an uplink bandwidth part (UL BWP) and a second frequency domain resource unit set; and/or
the second frequency domain resource comprises a frequency domain resource both in a downlink bandwidth part (DL BWP) and a fifth frequency domain resource unit set.

12. The apparatus according to claim 11, wherein
the second frequency domain resource unit set comprises a first sub-band, and the first sub-band and the UL BWP are configured for a same UL SCS specific carrier, and
the fifth frequency domain resource unit set comprises a second sub-band, and the second sub-band and the DL BWP are configured for a same DL SCS specific carrier.

13. The apparatus according to claim 12, wherein
one or more UL SCS specific carriers are configured within a cell,
one or more DL SCS specific carriers are configured within the cell,
one SCS is configured in each UL or DL SCS specific carrier respectively, and
in a case where more than one UL SCS specific carriers are configured, different UL SCS specific carriers are configured with a corresponding first sub-band, respectively; and
in a case where more than one DL SCS specific carriers are configured, different DL SCS specific carriers are configured with a corresponding second sub-band, respectively.

14. The apparatus according to claim 12, wherein the first sub-band and the second sub-band are composed of continuous resource blocks (RBs), and configurations of the first sub-band and the second sub-band are for a same cell.

15. The apparatus according to claim 11, wherein the receiver further receives first information and/or second information for indicating/configuring the second frequency domain resource unit set and/or the fifth frequency domain resource unit set, the first information and/or the second information being carried by an RRC message or a third configuration,
wherein the RRC message comprises one or more of the following:
a SIB1;
an RRC setup message;
an RRC resume message; or
an RRC reconfiguration message;
wherein,
the third configuration comprises one or more of the following:
SIB (system information block) downlink frequency information,
a SIB downlink common configuration,
SIB uplink frequency information,
a SIB uplink common configuration,
a SIB serving cell common configuration,
downlink frequency information,
a downlink common configuration,
uplink frequency information,
an uplink common configuration, or
a serving cell common configuration.

16. The apparatus according to claim 15, wherein the first information and/or the second information comprise(s) one or more first configurations, and each first configuration comprises information indicating one or more of the following:
a frequency domain location of a first sub-band, and a frequency domain location of a second sub-band;
the frequency domain location comprises: a start and/or an end and/or a center and/or a bandwidth.

17. The apparatus according to claim 1, wherein for the first time domain resource, a frequency domain resource other than the first frequency domain resource comprised in a UL BWP is not used for transmitting an uplink signal, and/or a frequency domain resource other than the second frequency domain resource comprised in a DL BWP is not used for receiving a downlink signal.

18. The apparatus according to claim 5, wherein the receiver further receives fourth indication information used for indicating periodic transmission directions of time domain resources, the fourth indication information cannot indicate the first time domain resource as downlink or uplink, and can indicate the second time domain resource indicated as being flexible by the third indication information as downlink or uplink.

19. The apparatus according to claim 18, wherein the fourth indication information cannot indicate the first time domain resource as downlink or uplink comprises that: the terminal equipment ignores information in the fourth indication information.

20. A signal transceiving apparatus, applicable to a network device, the apparatus comprising:
a transmitter configured to transmit first indication information for indicating a first time domain resource;
wherein in the first time domain resource, only a first frequency domain resource is used for receiving an uplink signal, or only a second frequency domain resource is used for transmitting a downlink signal; and
wherein the first indication information indicates a starting slot and an ending slot of the first time domain resource in a period, a starting symbol of the first time domain resource in the starting slot, and an ending symbol of the first time domain resource in the ending slot.
